(19) United States
(12) Patent Application Publication
(10) Pub. No.: US 2005/0015511 A1
(43) Pub. Date: Jan. 20, 2005

(54) Accelerated large data distribution in overlay networks

(75) Inventors: Rauf Izmailov, Plainsboro, NJ (US); Samrat Ganguly, Monmouth Junction, NJ (US); Nan Tu, Princeton, NJ (US); Aikaterini Varsou, West Windsor, NJ (US)

Correspondence Address: Jeffery J. Brosemer, Ph.D., ESQ., 138 S. Telegraph Hill Road, Holmdel, NJ, 07733, US

(73) Assignee: NEC Laboratories America, Inc., Princeton, NJ (US)

(21) Appl. No.: 10/749,947

(22) Filed: Dec. 31, 2003

Related U.S. Application Data
(60) Provisional application No. 60/484,322, filed on Jul. 2, 2003.

(51) Int. Cl. G06F 15/173

(52) U.S. Cl. 709/238

(57) ABSTRACT

A Method and apparatus for dynamically discovering and utilizing unused resources for practical and efficient creation of optimized network mechanisms for data distribution. Proposed techniques for data distribution, assembly, routing and scheduling in broadband networks can be implemented as content-level server platform architecture enabled by application-level control plane. Such a platform accelerates content transfer, mirroring and replication. It applies coordinated data partitioning and resource discovery and sharing of information replication by multiple network systems. Furthermore, it harvests the unutilized bandwidth in the network by disassembling the large content to be distributed into different components. These components are then routed in spatially and temporally diverse routes through multiple paths and trees and assembled at the destination nodes. The result is accelerated content distribution, added security, scalability and robustness. No modifications of existing network communication protocols is required.

### CROSS REFERENCE TO RELATED APPLICATIONS

This invention claims the benefit of U.S. Provisional Patent Application No. 60/484,322 filed Jul. 2, 2003.

### FIELD OF THE INVENTION

This invention relates generally to computer networks, and in particular to method(s) for finding and utilizing unused network bandwidth resources for creating multiple data forwarding paths on a heterogeneous computer network by means of an overlay network so as to reduce the data transfer time. The invention is embodied in a network system of cooperating nodes using data partitioning and reassembly and methods for routing and scheduling the connections.

### BACKGROUND OF THE INVENTION

Many existing communication networks are designed to transfer data in the form of Internet Protocol (IP) packets from a source to a destination. In order to meet the application requirements in terms of quality of services (QoS) and service level agreements, many proposals have been made that address resource reservation, provisioning, signaling, scheduling and routing at the IP layer. In practice, these proposals are rarely widely implemented because, for example, it is hard to coordinate their deployment into the Internet across multiple administrative domains.

As present, the Internet includes multiple connected domains, where each domain is controlled by policies dictated by the domain administrator. Consequently, it is hard to realize end-to-end service quality for the applications that require it.

To address this deficiency, overlay networks were developed that allow for application-layer coordination that does not rely on IP layer methods. By being decoupled from the IP layer methods, the overlay network can be tailored to the requirements of specific applications. For example, in the case of Web services, efficient content caching and replication on servers geographically closer to end-user clients, shortens web response time (http://www.akamai.com).

In the current and future variations of the Internet, and in particular with the proliferation of content intensive applications, one requirement will be to distribute very large content among diversely located servers. The importance of fast transfer of rich content is difficult to overstate with the envisioned number of high bandwidth applications. For example, with video-on-demand programming, it is essential to update edge servers with large video contents (movies, TV programming) from the central servers. In network attached storage (NAS, http://www.sun.com/storage/white-papers/nas.html) appliances, large pieces of data files need to be updated, replicated or reconciled at remote storage locations inter-connected by IP networks. Software companies and enterprises require updating mirror sites with their software products. In E-science collaboration (http://www.ukoln.ac.uk/events/iisc-cni-2002/presentations/tony-hey.doc), experimental data of the order of peta-bytes are moved from geographically distributed locations using an underlying IP network.

Each of the above-mentioned applications (as well as others) can greatly benefit from faster data transfer. The acceleration of content transfer requires mechanisms that can extract greater bandwidth from networks than what is presently generally available from existing IP layer mechanisms.

Prior art attempts to distribute bulk data from existing IP mechanisms have taken many forms. In an article entitled “A multicast transmission schedule for scalable multi-rate distribution of bulk data using non-scalable erasure-correcting codes”, which appeared in Proc. IEEE Infocom 2003, authors Y. Birk and D. Crupnicoff describe a content encoding approach, where content fragments are separately coded as a group and scheduled for transmission. And while this approach attempts to address the scalability issues associated with bulk transfer, it does not use spatial diversity from multiple paths or trees to enhance the transfer speed.

Similarly, J. W. Byers, M. Luby and M. Mitzenmacher, in an article entitled “Accessing multiple mirror sites in parallel: using tornado codes to speed up downloads”, that appeared in Proc. IEEE Infocom 1999 and an article by J. Byers, J.

Considine, M. Mitzenmacher and S. Rost, entitled “Informed content delivery across adaptive overlay networks”, that appeared in Proc. ACM SIGCOM '02, describe mechanisms for the faster download of content. The applicability of these mechanisms, 10 however, is restricted only to content download and final download time is dependent on how parallel downloads used are routed in the overlay network. Since the disclosed methods employ no knowledge about the network topology or available bandwidth at different overlay links, they do not exhibit beneficial route optimization or scheduling, and therefore suffer from performance limitations.

U.S. Pat. No. 6,266,339, for a “High Bandwidth Broadcast System Having Localized Multicast Access To Broadcast Content” issued to Donahue et. al, on Jul. 24, 2001, describes a method for multicasting digital data to a user accessing an Internet connection. The data is transmitted from a transmission site to a remote Internet point of presence through a dedicated transmission channel substantially separate from the Internet backbone. At the remote Internet point of presence, the data is multicast for delivery to at least one receiving Internet user's apparatus connected to but distal from the remote Internet point of presence. This method too, fails to provide the performance benefits in terms transfer time derived from multiple trees and paths connecting the source and destination nodes.

Additionally, U.S. Pat. No. 6,275,470, issued to Ricciulli, discloses methods and apparatus for dynamically discovering and utilizing an optimized network path through overlay routing for the transmission of data. The method determines whether to use a default or an alternate data forwarding path through one or more overlay nodes, based on cost metrics such as delay, throughput, jitter, loss and security. However beneficial, the methods disclosed therein is limited to point-to-point applications, and not applicable to point-to-multipoint or multipoint-to-multipoint data delivery.

Finally, in U.S. Pat. No. 6,535,487, which issued to Biswas et. al, on Mar. 18 2003 for “Connection Splitting: An Efficient Way Of Reducing Call Blocking In ATM”, teaches a technique for reducing Asynchronous Transfer Mode (ATM) call blocking that splits wideband connections into multiple low-bandwidth sub-connections and routing them independently through the network. Advantageously, the system disclosed therein implements splitting without requiring protocol changes within the network, however it is applicable only in ATM networks.

In view of the limitations associated with the prior art, a continuing need exists for methods that provide enhanced transmission and distribution of data and/or content over existing networks. Such method(s) is/are the subject of the present invention.

### SUMMARY OF THE INVENTION

We have developed methods and systems that shorten the transmission transfer time—as compared with prior art methods—of bulk data between a source and a destination in a computer-based communication network. In particular, our inventive methods discover multiple routes between the source and destination, fragment the bulk data, schedule, and then simultaneously transmit the data fragments over the discovered, multiple routes, thereby increasing the total available bandwidth for the bulk data transfer and decreasing the amount of time to transport the bulk data transfer.

Advantageously, our methods and apparatus according to our invention work transparently—without modification to the communication network—permitting an incremental deployment, for example, by adding more network servers. Of further advantage, the bulk data transmitted according to our inventive teachings, may be part of a very-large content deployment, requiring rapid deployment.

Viewed from a first aspect, the present invention is directed to method(s) and apparatus that—in response to requests for transmission of data—discovers a plurality of transmission paths and trees between multiple end servers. Additionally, our inventive method and apparatus partitions the original data based on the discovered paths and trees. Lastly, our inventive method and apparatus transmits the data partition(s) using the discovered paths and trees and subsequently reassembles the original data from the received data partition(s), after scheduling an appropriate transmission time for each data partition on the selected paths and trees.

Viewed from another aspect, our invention is directed to methods and apparatus for transferring bulk data from a single source to a plurality of destinations or from a plurality of sources to a single destination using, for example, plurality trees. In an exemplary embodiment of our invention, the transmission capacity between the end nodes and the processing capacity of the end nodes in an overlay network can be reserved. In another exemplary embodiment, the capacity between end nodes in the overlay network can be monitored or inferred. In yet another exemplary embodiment of our inventive methods and apparatus, the discovery process may be performed in either a centralized or a distributed manner. Advantageously, the transport protocol for transmitting data through a selected path can be based on any reliable means such as Transmission Control Protocol (TCP) or User Datagram Protocol (UDP) with erasure coding.

Additional objects and advantages of the present invention will be set forth in part in the description which follows, and, in part, will be apparent from the description or may be learned by practice of the invention.

### BRIEF DESCRIPTION OF THE DRAWING

Further objects of the invention will be more clearly understood when the following description is read in conjunction with the accompanying drawing and figures in which:

FIG. 1 shows a sample network and its equivalent overlay network according to the present invention;

FIG. 2 shows an exemplary data transmission method between a given source and destination;

FIG. 3 shows an alternative method to that of FIG. 2 wherein data is disassembled into three portions and independently transmitted from the same source to the same destination;

FIG. 4 shows a generalization of the point-to-point transmissions of FIG. 2 and FIG. 3 to a point-to-multipoint transmission wherein data transmitted from the source is sent to a set of different destinations;

FIG. 5 shows a further generalization of FIG. 2 and FIG. 3 to a multipoint-to-multipoint transmission wherein data is sent from a given set of sources to a given set of destinations;

FIG. 6 shows data disassembly and assembly and routing with spatial diversity achieving bandwidth mining, according to the present invention;

FIG. 7 shows our inventive method for achieving temporal diversity through content scheduling;

FIG. 8 shows a sample network and a graph comparing the performance of different algorithms for this network;

FIG. 9 shows how computed trees will dynamically change once a network change is discovered;

FIG. 10 is a flow chart depicting the procedure of data transmission over an overlay network according to the present invention;

FIGS. 11(a) and 11(b) show exemplary software architecture(s) according to the present invention;

FIG. 12 is a flow chart depicting an example of a forwarding process at overlay network layers according to the present invention; and

FIG. 13 is a flow chart depicting a method of dynamic scheduling of data transfer at a data source according to the present invention.

### DETAILED DESCRIPTION

According to the present invention, content—in the form of bulk data—is distributed through a network comprising of one or more sources, routers and edge servers (destinations) that are connected through a combination of unidirectional and/or bidirectional links. These links are associated with a bandwidth capacity that is either assigned by several algorithms or inferred in the network.

The content that is to be distributed can either be the same or different for the different destinations. In particular the bandwidth of the links is harvested such that once a multicast tree is determined, the bandwidth of the unutilized links is used as a result of the construction of one or more multicast trees and so on. Furthermore, the content may be disassembled into smaller pieces at the source(s), and then routed through the constructed multiple tree(s) to the destinations, where the separate, smaller pieces are reassembled. Lastly, during its routing through the tree(s), the content may be stored in intermediate nodes or replicated as required.

As noted before, the present invention provides a mechanism(s) for accelerating the transmission of data from source nodes to destination nodes on a computer network such as the Internet, for example, without requiring any modification to existing communication protocols. Our inventive mechanism(s) preferably combine an overlay routing and scheduling mechanism with the discovery of multiple paths and trees along with data partition and may be briefly summarized as follows:

An overlay network is constructed on top of the existing network (for example, the Internet) routing mechanisms where nodes of an overlay network are acting as cooperating servers. Advantageously, the overlay routing mechanism is completely transparent and decoupled from the Internet routing protocols.

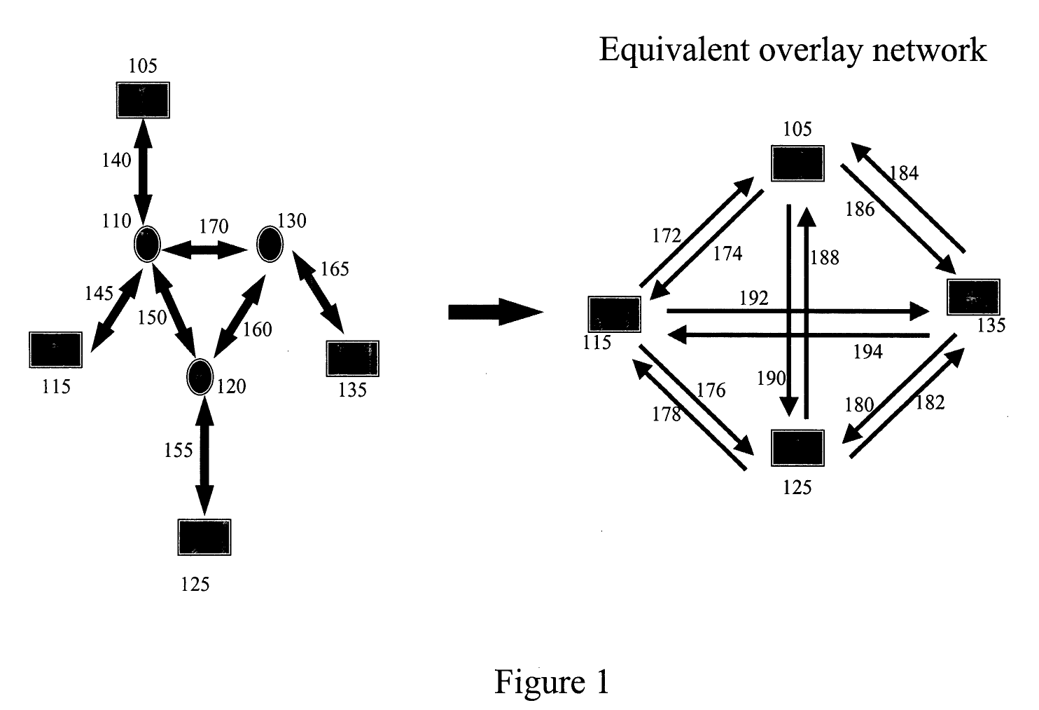

As can be appreciated, such an overlay network can be preferably deployed by having geographically distributed servers connected by a communication network such as the Internet. FIG. 1 shows the concept of an overlay network. Specifically, the overlay network preferably includes a number of computing devices or servers (105, 115, 125 and 135) that are connected through an underlying IP network consisting of routers (110, 120 and 130) via underlying links (140-170). Servers (105, 115, 125 and 135) cooperate among themselves to provide forwarding paths over an underlying network.

Overlay network nodes or servers preferably communicate using existing, established Internet Protocols and thus do not require any modification to current standards. The overlay network thus becomes a virtual network, as shown in the right of FIG. 1 that includes servers 105, 115, 125 and 135. Virtual links (172-194), connecting the overlay nodes or servers correspond to the point-to-point routes connecting a pair of servers.

According to our invention, data is routed from a source to a plurality of destination nodes on the overlay network. The routing is done over multiple paths and trees that connect the source node to the plurality of destination nodes. Creation of the multiple paths and trees maximizes the total bandwidth available for data transfer and thus minimizes the transfer time.

In order to use the multiple paths, the data at the source is partitioned based on the available bandwidth of each tree. Using the overlay nodes, these data partitions are then forwarded to the destination nodes, where they are re-assembled to construct the original data. Advantageously, the creation of the trees and paths can be either static, where network resources are reserved, or dynamic, where network resources are not reserved. Still further, the construction of trees may be based on monitoring the underlying network resources.

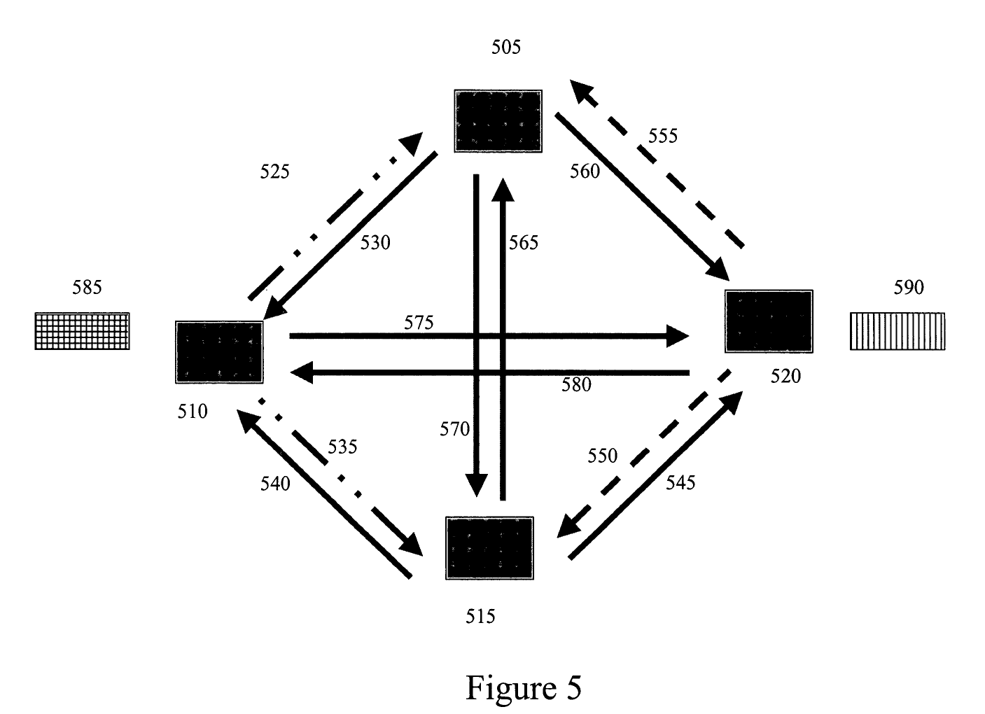

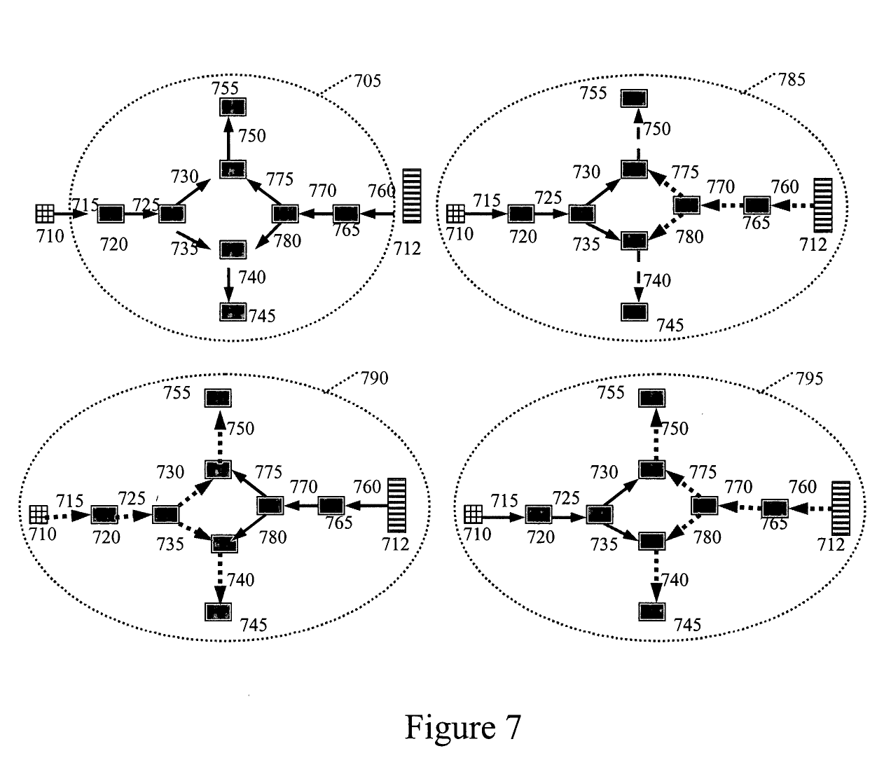

At this point, it is useful to note that our inventive method(s) and apparatus provides for the scheduling of a data transfer when there is a plurality of simultaneous sources involved. Turning our attention now to FIG. 5, it shows two source nodes, namely 510 and 520 that are attempting to transfer data to a set of destinations, namely 505 and 515. In particular, source 510 desires to transfer data 585 to destinations 505 and 515, which is performed via links 525 and 535. At the same time, source 520 needs to transfer data 590 to destinations 505 and 515, which is performed via links 550 and 555. Further details and mechanisms for scheduling when multiple simultaneous sources are involved will be described in detail later, during a discussion of FIG. 7.

Additionally, our invention provides for the data transfer through cooperating overlay nodes, on-demand routing using overlay nodes, as well as monitoring of underlying IP network resources. In order to have the current status of the overlay network, each overlay node monitors the participation of the other overlay nodes. By this monitoring, each overlay node is aware of the present status of other overlay nodes in terms of their cooperation for forwarding paths. By having on-demand routing, optimized routes are constructed by having forwarding paths through the overlay network only at the time of data transfer. The discovery of the overlay paths is based on monitoring the cost and performance metrics of interest (preferably the available bottleneck bandwidth) between each overlay node pair corresponding to a virtual link.

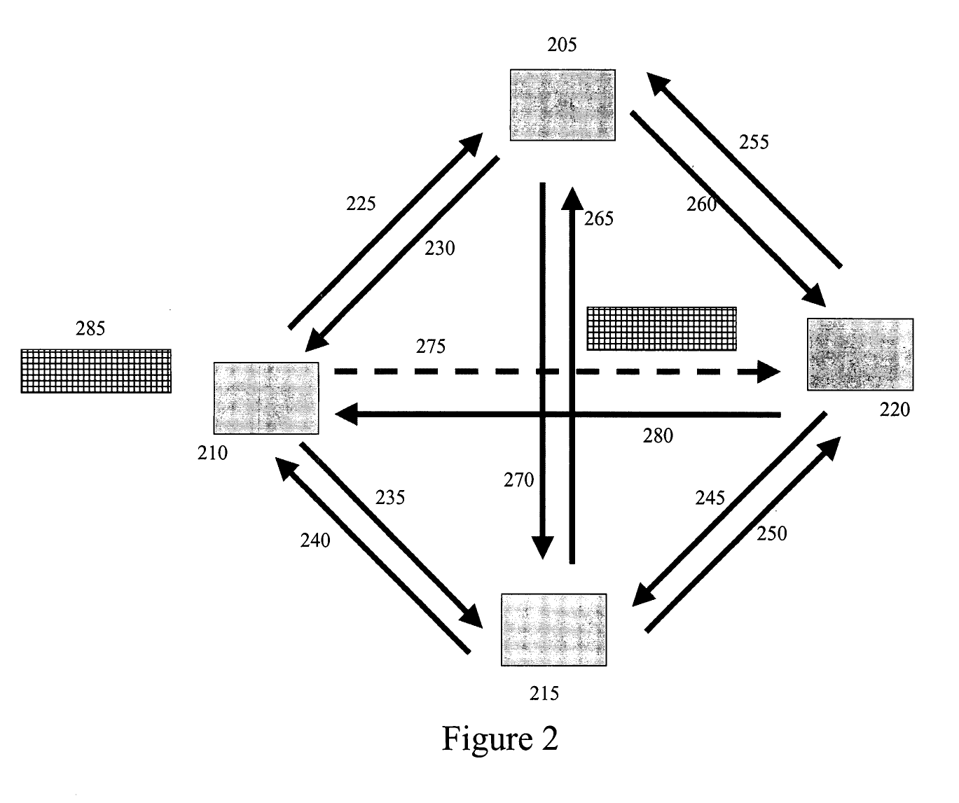

Recall, existing data transfer mechanisms between a source and a destination are done using a single unicast routing path from that source to that destination. With initial reference now to FIG. 2, there is shown such a transfer between nodes 210 and 220, where the unicast path between 210 and 220 is represented by a virtual link 275 in the overlay network. As can be readily appreciated by those skilled in the art, the bandwidth available for data transfer when using such a single, unicast mechanism is limited by the bottleneck bandwidth in the virtual link 275.

In sharp contrast, and according to the present invention, more bandwidth is extracted from the network thereby accelerating the data transfer rate by discovering and then utilizing multiple paths between the source and destination.

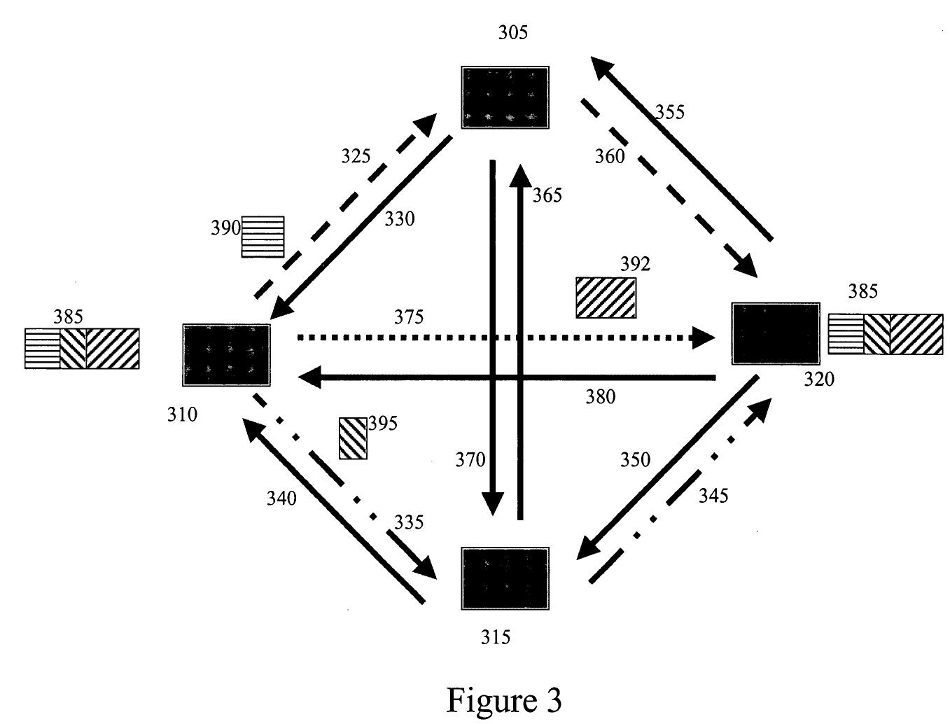

Turning our attention now to FIG. 3, there is shown—according to our inventive teachings—the creation of three multiple paths between source 310 and destination 320 using the overlay nodes. In particular, the first path traces the overlay nodes 310, 305 and 320 in order, traversing the virtual links 325 and 360. The second path traces the overlay nodes 310 and 320 in order, traversing the virtual link 375. The third path traces the overlay nodes 310, 315 and 320 in order, traversing the virtual links 335 and 345. As should be apparent, by discovering multiple paths between the source 310 and destination 320, the present invention increases the effective bandwidth available between the source 310 and the destination 320.

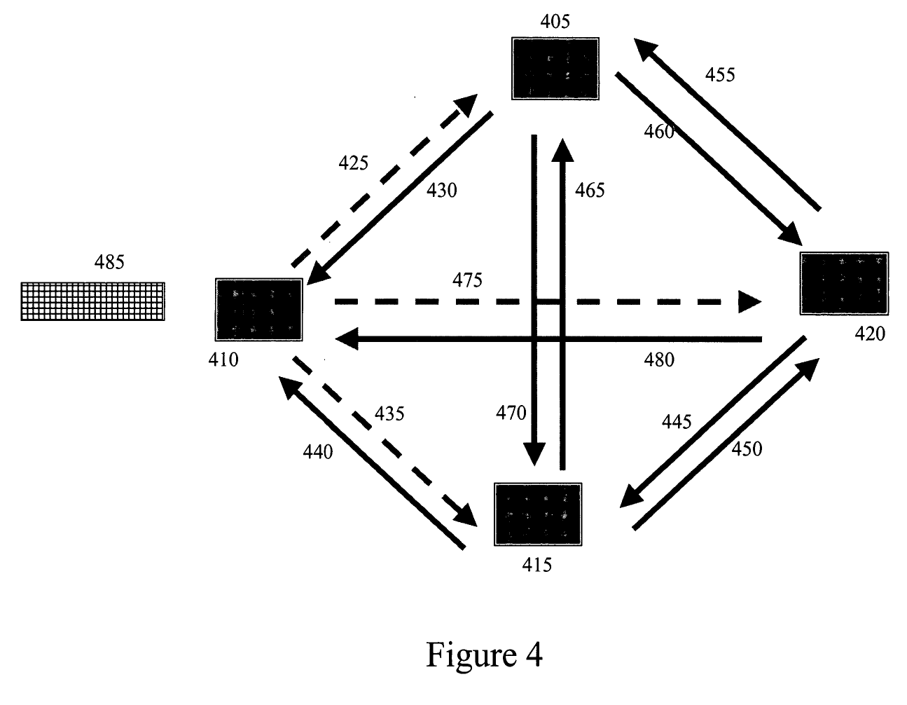

Of additional advantage, our inventive method and apparatus may be used for transmitting data from a single source to multiple destinations in an overlay network. Specifically, FIG. 4 shows the transfer of data 485 from source 410 to a set of destinations, namely 405, 415 and 420. In a preferred embodiment of the invention, a multicast tree is created—connecting source 410 to destinations 405, 415 and 420—that minimizes the total time to transfer the data. One such multicast tree on the overlay network is shown in FIG. 4 and includes virtual links 425, 475 and 435.

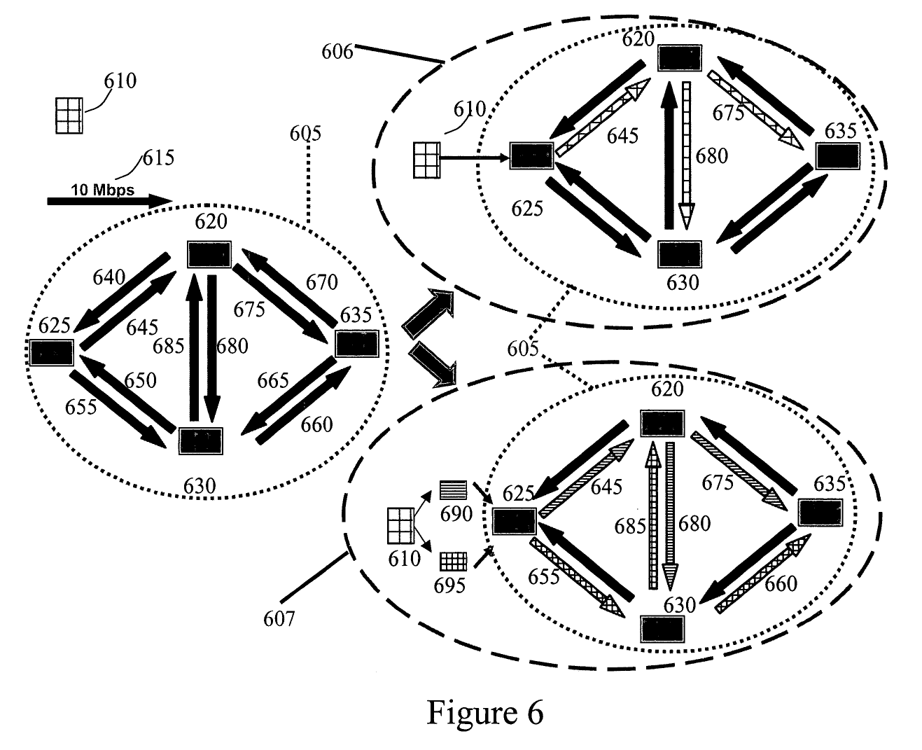

Additionally, our invention constructs multiple multicast trees, thus providing further improvement of the single multicast tree. As an example, let us consider FIG. 6, which shows a large (400 MB) data file 610 that needs to be transmitted through the network 605 using, for example, a 10 Mbps transmission rate 615. Of course those skilled in the art will readily appreciate that this 10 Mbps transmission rate 615 is merely exemplary, and our inventive methods and teaching will advantageously apply to different transmission rates as well.

Returning now to FIG. 6, the network shown therein includes a source 625 and a set of destinations 620, 630 and 635 that are connected through links 640 to 685. The data file to be distributed 610 will originate from the source 625 and will reach all destinations 620, 630 and 635.

Within this FIG. 6, there is shown two distinct approaches to the data file distribution and represented in the FIG. 6 by bubbles 606 and 607. Specifically, in bubble 606, the data file 610 of size 400 MB needs to be distributed through network 605 between source 625 and destinations 620, 630 and 635. To realize the distribution, a multicast tree is created, comprising links 645, 680 and 675, depicted in network 605 of bubble 606. With such a scenario, assuming the 10 Mbps transmission rate, a multicast delay of 40 seconds is realized.

An alternative approach according to our invention is shown in bubble 607. With specific reference to that bubble 607, in order to distribute data file 610 through network 605, from source 625 to destinations 620, 630 and 635, the data file 601 is first disassembled into two, smaller files 690 and 695. Then, our inventive bandwidth harvesting identifies two different multicast trees, a first one including links 645, 680 and 675 and a second one including links 655, 685 and 660, and shown in network 605 of bubble 607. Each of the smaller files 690 and 695, is distributed along these two multicast trees—resulting in a multicast delay of only 20 seconds. As can be readily appreciated by those skilled in the art, our inventive method advantageously reduced the multicast delay of a large file transfer by a factor of two. Accordingly, and as can be readily appreciated, the unutilized bandwidth in a network can be used efficiently to accelerate large data delivery which, according to our invention, is disassembled into multiple components and routed in spatially diverse routes and then reassembled at the destination.

Our inventive method and apparatus is not limited to the single source scenario described previously. Advantageously, our invention is applicable to situations where multiple sources transfer data to multiple destinations simultaneously. In order to coordinate the multiple data transfer originating from multiple sources however, our inventive method schedules the data transfer to further facilitate its transmission.

As an example of the impact of our inventive scheduling, let us consider FIG. 7, where two data files 710 and 712, need to be distributed through the network 705 to the destinations 745 and 755. The network 705 includes links 725, 730, 735, 740, 750, 770, 775 and 780. Data file 710 will arrive at the server 720 and will use a route in the network 705, to arrive at destinations 745 and 755. Similarly, data file 712 will reach server 765 and will use a different route in the network 705 to arrive at destinations 745 and 755.

The simultaneous transmission of the data files 710 and 712 is depicted in scenario bubble 785 of FIG. 7. Specifically, data file 710 is delivered to node 755 through links 725, 730 and 750. It is also delivered to node 745 though links 725, 735 and 740. Simultaneously with the transmission of data file 710 as described above, data file 712 is transmitted as well. In particular, it is delivered to node 755 through links 770, 775, 750 and to node 745 through links 770, 780, 740.

Unfortunately, this simultaneous transmission scenario 785 is not completely efficient, due in part to links 750 and 740 being shared. Alternatively, and according to our invention, transmissions may be scheduled, by transmitting data file 710 first and data file 712, second. Sending data file 710 first is depicted in bubble 790 of FIG. 7. Specifically, data file 710 is transmitted to node 755 via links 725, 730, 750, and transmitted to node 745 via links 725, 735, 740. The subsequent transmission of data file 712 is depicted in bubble 795 of FIG. 7. Accordingly, data file 712 is transmitted to node 755 via links 770, 775, 750 and transmitted to node 745 via links 770, 780, 740. We have found that the scheduling of data file transmission such as that depicted in bubbles 790 and 795 of FIG. 7, provides efficient utilization of resources and reduces the average delivery time.

According to one embodiment of our inventive method and apparatus, when transmitting data from a single source to multiple destinations, multiple forwarding trees are constructed from the source to the destination nodes. This construction of the trees is based on an image of the network resources available.

As should now be apparent, multicast paths are created to minimize the total time of data file delivery to all destinations. In order to achieve that, several multicast trees are first constructed from the source to the destination. Each multicast tree is assigned a bandwidth that corresponds to the rate of forwarding data using that multicast tree. The trees' construction method preferably should ensure that the sum of the assigned bandwidth to the multicast tree is less than the available bandwidth in each virtual link that is part of any multicast tree. Based on the assigned bandwidth, the original data is partitioned and forwarded accordingly through the corresponding multicast trees.

In one embodiment of the invention, the multicast paths from a source to a set of destinations are constructed using a depth-first-search (DFS) methodology. Using DFS, all nodes are discovered and are connected by the DFS tree. The DFS tree is then compressed to include only the nodes that are in the set of destination nodes and the intermediate nodes that are in the path to the destination. The minimum bandwidth among all the links in the DFS tree is assigned as the bandwidth of this multicast tree. This assigned bandwidth is then subtracted from all the links in the current tree and the next tree is constructed in the above-mentioned way. The tree construction process stops when the bandwidth that can be assigned to a tree becomes zero.

In yet another embodiment of the invention, the multicast paths from a source to a set of destinations are constructed using a breadth-first-search (BFS) methodology. Using BFS, all nodes are discovered and are connected by the BFS tree. This BFS tree is then compressed to include only the nodes that are in the set of destination nodes and the intermediate nodes that are in the path to the destination. The minimum bandwidth among all the links in the BFS tree is assigned as the bandwidth of this multicast tree. This assigned bandwidth is then subtracted from all the links in the current tree and the next tree is constructed in the above-described way. The tree construction process stops when the bandwidth that can be assigned to a tree becomes zero.

In still another embodiment of the invention, the multicast paths from a source to a set of destinations are constructed using a maximum bandwidth-shortest-path (MBSP) methodology. According to this method, the shortest path tree that maximizes the bandwidth from source to destination is constructed. The MBSP tree is then compressed to include only the nodes that are in the set of destination nodes and the intermediate nodes that are in the path to the destination. The minimum bandwidth among all the links in the MBSP tree is assigned as the bandwidth of this multicast tree. This assigned bandwidth is then subtracted from all the links in the current tree and the next tree is constructed in the aforementioned way. The tree construction process stops when the bandwidth that can be assigned to a tree becomes zero.

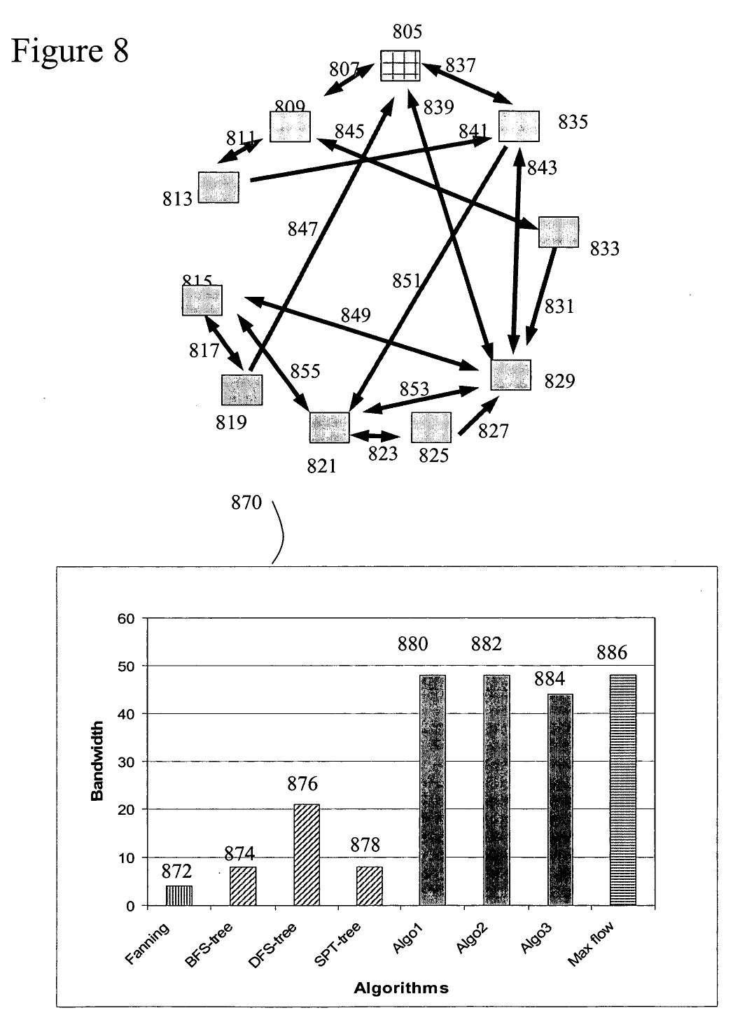

With this discussion of multicast tree construction completed, it is useful to compare the performance of the various methods. With reference now to FIG. 8, there is shown an exemplary network and a bar-graph depicting the different performance characteristics of the different methods as applied to that exemplary network. Specifically, and with reference to the network diagram depicted in FIG. 8, source 805 is sending data to destinations 809, 813, 815, 819, 821, 825, 829, 833 and 835. The source and destinations are connected through bidirectional and unidirectional links 807, 811, 817, 823, 827, 831, 837 and 839-855 exhibiting specific bandwidths, as shown in the FIGURE.

Also shown in FIG. 8, is a bar-graph 870, comparing the different methods in terms of bandwidth utilization for the network in FIG. 8. The specific methods compared are Fanning (872), BFS (874), DFS (876), Spanning tree (878), the various preferred methods of this invention Alg01 (880), Alg02(882), Alg03(884) and maximum flow (886). These results show that the best of the methods as taught by this invention reaches the optimum of maximum flow 886.

Advantageously, the construction of the paths and trees over the overlay network can be done in a centralized fashion. In a centralized fashion, either any node among the participating overlay nodes can be selected as the central route server or the source for the data transfer can act as the route server. The responsibility of the route server is to construct multiple paths and trees to the destinations. In centralized route constructing, each overlay node sends its status to the central route server. The current image of available resources of the network is also known at the central route server. Based on the available information, the central server discovers routes for the requested data transfer and disseminates the forwarding information related to the constructed path to the required overlay nodes.

Additionally, the construction of the paths and trees over the overlay network can be done in a distributed fashion. In the distributed approach, each server node participating in the data transfer makes a local decision about the forwarding of the received data. The local decision is based on each node's local monitoring of the network resources. Distributed construction of paths avoids signaling overhead and is scalable to larger size overlay networks.

Furthermore, the construction of paths and trees on the overlay network can be done in a hierarchical fashion. In this approach, overlay nodes can be grouped as domains with a central node per domain to form a two level hierarchy. In this hierarchy, top-level tree construction will span central nodes for each domain. The second-level tree then can be constructed from the central node spanning the nodes in his domain. The decision in creating the trees then becomes limited to nodes participating in each level of hierarchy. Such a two level hierarchy can be increased to more levels depending on the size of the overlay network and required performance issues. Using hierarchical construction distributes the construction process, increases scalability and results in a system that is more robust to changes in bandwidth.

A way to transfer data in a network where the available bandwidth can change over time is to employ a dynamically modified multicast tree. In this embodiment, the initial tree is constructed based on the current image of the network resources. At a future time, when the bandwidth on a virtual link in the overlay network changes, the tree is reconfigured dynamically by monitoring the current available bandwidth. The modification of the tree thus adapts to the changing bandwidth condition and tries to achieve the most optimized tree for the current network status in terms of available bandwidth.

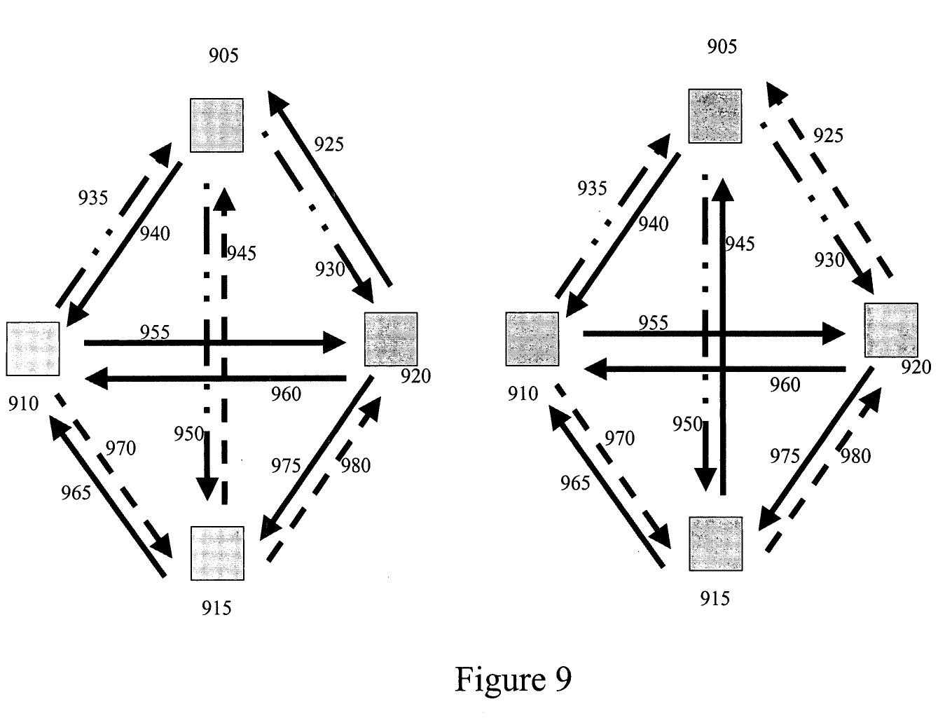

FIG. 9 shows how the method for tree computation adapts as the network dynamics change. In this network scenario (shown in the left network diagram of FIG. 9), source 910 is transmitting data to destinations 905, 915 and 920. In analyzing this network, two trees are found, a first tree comprising links 935, 950 and 930 and a second tree comprising links 970, 945 and 980.

Based on the network dynamics and change in the available bandwidth in the link 945, the method advantageously reconfigures the second trees such that it now comprises links 970, 980 and 925, as shown in the right network diagram FIG. 9. This reconfiguration may (but not necessarily) have been caused by a variety of reasons, for example, a decrease in the available bandwidth in link 945, such that the available bandwidth in link 925 is now greater than the available bandwidth in link 945.

In that situation where the available bandwidth in each of the trees is not constant over time, an offline partition of the data into pieces can be performed by a dynamic partition of the data. In the dynamic partition of the data, the data is broken into small, substantially equal size fragments. The size of the fragment is determined by weighing the scalability/overhead versus performance characteristics. These equally sized fragments are then scheduled for transmission over the trees based on current bandwidth availability.

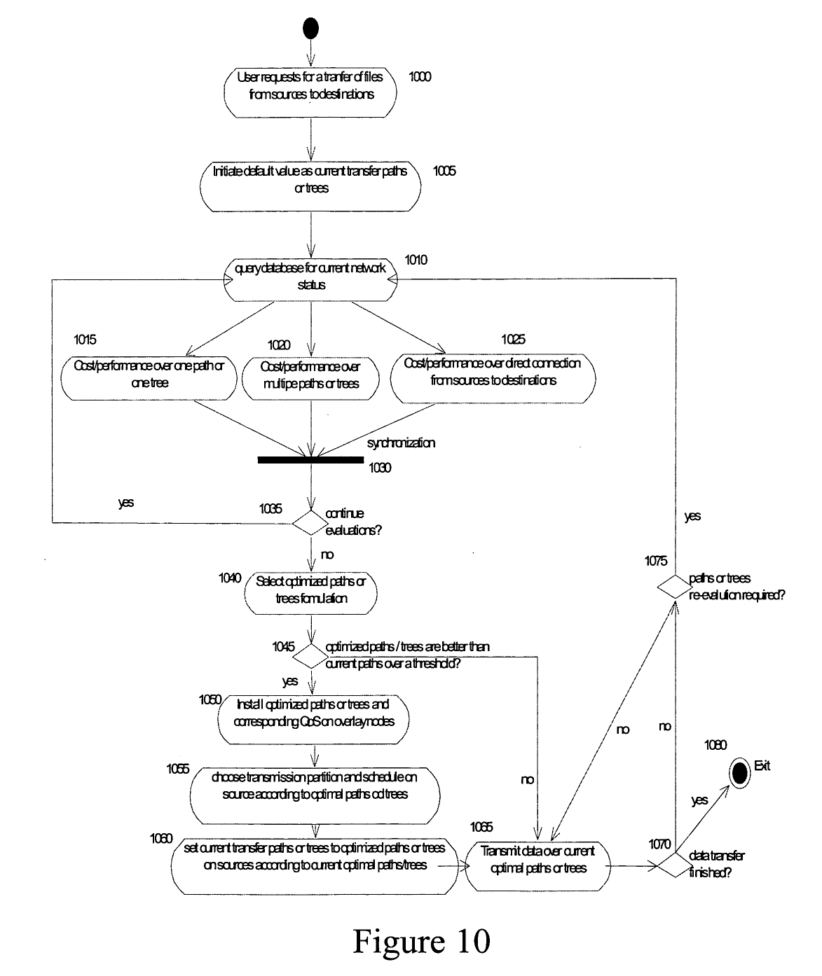

As should be apparent to those skilled in the art, the present invention provides an optimized method for data transfer over an overlay network in a cooperative manner. The procedure of a data transfer according to the present invention is described in FIG. 10. With reference to that FIG. 10, data transfer is initiated by sending a request specifying the data sources and destinations 1000 and initializing default paths and trees 1005. Optimized transfer paths and trees are cooperatively chosen by the overlay network as a result of the request according to the current network conditions 1010-1040. If the optimized transfer paths or trees are better than the previous paths or trees 1045 over a threshold, the new transfer paths or trees are setup 1050 and a data partition and scheduling method(s) are chosen 1055. Data is transferred using the new optimized paths or trees 1060-1065, otherwise, the data is transferred using the previous paths and trees. If re-optimization of the paths or trees is required 1075, the evaluation process 1010,1015,1020,1025 is re-performed. The data transfer then continues until all of the data is transferred 1070.

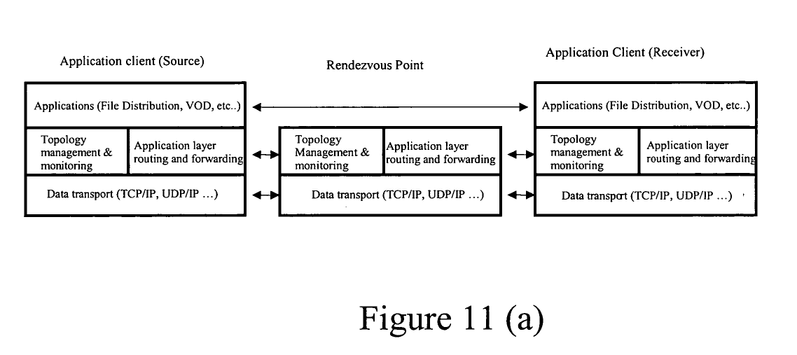

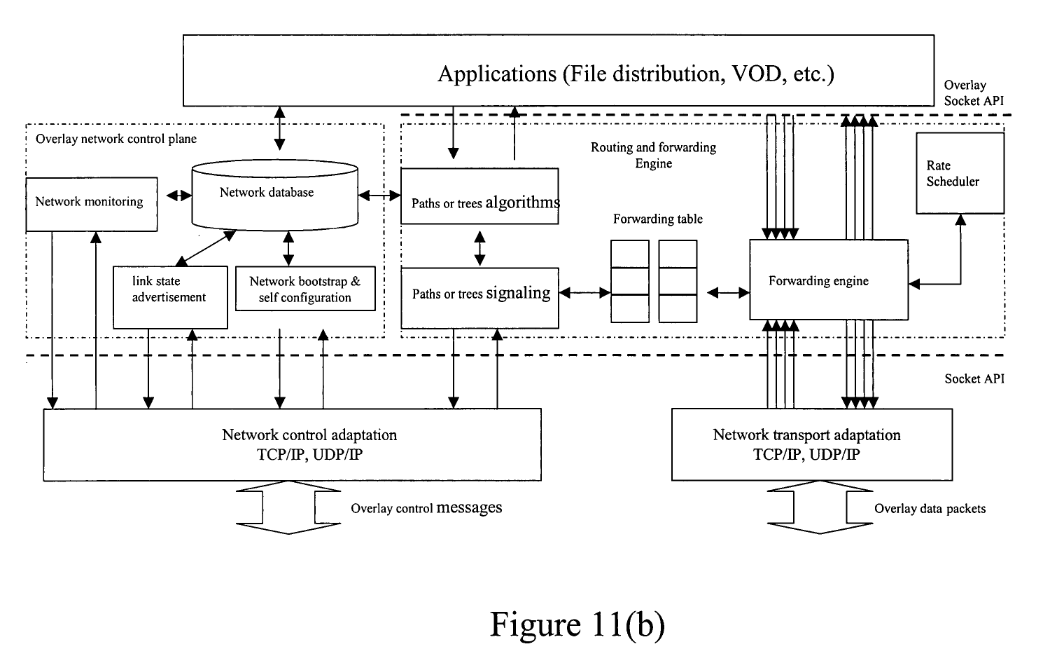

At this point, it is useful to describe an exemplary software architecture according to the present invention. From a software layer perspective, and as shown in FIG. 11(a), the exemplary software architecture of the present invention and shown in that FIGURE includes three layers, namely the bottommost, underlay network transport layer; the middle, overlay network management and transport layer and the uppermost, application layer.

Functions performed within the bottommost underlay network transport layer include a network transport service such as Transmission Control Protocol (TCP), User Datagram Protocol (UDP), Real-time Transport Protocol (RTP) or the like, depending on the application requirements. In the middle, overlay network management layer, functional modules including the forwarding engine, routing protocols, network monitoring, network topology learning and network self-configuration. The network layer creates an overlay data transfer service. At the application layer, each application, such as file distribution, file replication or the like, performs application layer framing (ALF), scheduling and coding and interacts with the overlay network layer of the present invention for data transmission.

Turning our attention now to FIG. 11(a), there is shown in peer perspective the software architecture of the present invention including its two major components, a Rendezvous Point (RP) with only a network layer component and an Application Client (Source and Receiver) that has both network layer and application layer components.

While not explicitly shown in FIG. 11(a), the RPs are located at strategic locations in the network and accept the application client requests for data transmission. RPs can also be collocated with the application client if they prefer to share resources for data transmission of other clients.

In both networks with provisioned and non-provisioned bandwidth, the topology of a transmission path or tree is based on the optimization method, taking into account the current network conditions discussed earlier. The signaling and resource reservation of a forwarding path or tree is realized through a path pinning protocol. In a network with non-provisioned bandwidth, the connections between overlay nodes can vary due to network congestion and failures. Advantageously, the network monitoring component of the present invention senses such changes and uses link state advertisements to propagate them to other participating nodes in the overlay network.

According to the present invention, a preferred way of bootstrapping a node (including RP and application client) into the overlay network, is to use a directory service, either centralized or distributed, (such as Domain Name System (DNS) or Distributed Hash Table (DHT)), to find a list of nodes in the network and connect them randomly or according to some optimization criteria. As can be appreciated, the optimization criteria can be geographical proximity, network bandwidth, network latency, etc.

With reference now to FIG. 11(b), the components shown therein comprise the major system building blocks of the present invention providing cooperative data transmission in an overlay network leveraging spatial and temporal diversity. Each of these components is discussed in turn in the sections that follow.

Before that discussion however, it is useful to note that in an overlay network, routing is the process of building up the forwarding tables or the like on the overlay nodes and using them to select transmission paths for the data. As can be appreciated, both source routing and hop-by-hop routing may be used to implement overlay paths or tree forwarding mechanisms.

Because of high bandwidth and processing load of source routing however, the preferred mechanism of the present invention is hop-by-hop routing. In a hop-by-hop routing process, the application data frame from the data source is transmitted to an intermediate node. The intermediated node then forwards the data frame to the next intermediate node by using the forwarding table or the like. A preferred method to realize hop-by-hop routing according to the present invention is to setup forwarding tables and perform data forwarding based on them.

For a tree-based data transmission, such as point-to-multipoint or multipoint-to-multipoint, each overlay node maintains a tree-forwarding table. Each entry in the forwarding table includes a tuple {tree identifier, next-hops, QoS}, in which “next-hops” identifies all the neighbors on the tree and “QoS” specifies the QoS descriptor of the corresponding data transmission over the tree. One use of the QoS descriptor, for example, is to specify the sending rate over the tree. The term “tree identifier” is similar to the label in Multi-protocol label switching and the flow ID in IPv6. As can be appreciated, it helps support multi-hop routing by speeding up the forwarding process at each intermediate node. The preferred way of implementing a forwarding table is to use a hash table with lookup complexity in O(1).

For a path-based data transmission, such as point-to-point and multipoint-to-point transmission, the preferred forwarding table includes a tuple {flow identifier, next hop, QOS}, in which “next hop” is the neighbor identifier on the path. Using a tree identifier or a flow identifier instead of an MPLS label simplifies the table setup process by avoiding MPLS's requirement of an upstream router to request a label mapping from a downstream router. The drawback of this arrangement, however, is a certain loss of flexibility, since the tree identifier has to be globally unique. To guarantee the global uniqueness of the tree identifier, a preferred way is to use concatenation of the source identifier and the local tree identifier of the data source. To solve the problem of global uniqueness of the flow identifier, a preferred way is to use concatenation of the destination identifier and the local flow identifier of the destination. Other mechanisms, such as using Message Digest 5 (MD5), over a combination of source and destinations, can provide another solution for generation of unique global identifiers. Note that the terms “tree forwarding” and “flow forwarding” are used interchangeably unless noted otherwise.

A preferred way of setting up forwarding tables in the present invention is to use explicit forwarding table setup. Trees or paths are computed on demand. Then an explicit forwarding table setup process is triggered to lay down the paths.

In point-to-multipoint data transmission, the initiator of the forwarding table setup is typically either the data source or centralized brokers. For multipoint-to-multipoint data transmission, the initiator of the forwarding table setup is typically a centralized broker that can be elected from all data transmission participants. For point-to-point data transmission, the preferred initiator of the forwarding table setup is either the data source or the destination.

The initiator of forwarding table setup of the transmission patterns listed above also acts as a coordinator of the forwarding table setup process. To enable the coordinating functions, any change of the forwarding table in a transmission session due to a network change, such as node joining and leaving, network congestion etc, has to be synchronized at the coordinator (or initiator). In the case of global resource sharing and management, the preferred initiator is a centralized broker similar to Common Open Policy Service (COPS). Note that the initiator and coordinator are interchangeable unless noted otherwise.

According to the present invention, explicit forwarding table setup can use either of the following methods: (1) Initiator sends messages to each node in a unicast fashion; (2) Initiator starts a hop-by-hop pinning process such as that described in Constrained Routing Label Distribution Protocol (CR-LDP, Uyless Black, “MPLS and Label Switching Networks”, Prentice Hall, 2001) in MPLS.

In the preferred unicast setup, the initiator encodes the forwarding table entry for a node into a message and sends it to the corresponding node in a unicast fashion. On receiving such a message, the node extracts the forwarding table entry from the message and installs it in its forwarding table.

In the preferred hop-by-hop pinning setup of trees, the initiator encodes the description of each tree into a message and sends it to the first node of the tree. On receiving such a message, a node performs the following 4 steps:
(1) Extracts the corresponding forwarding entry and installs it in the forwarding table for the corresponding tree;
(2) For each child on the tree, extracts the sub-tree description rooted at the child from the received tree description, encodes it into a new message and sends it to the corresponding child;
(3) If the node does not have any children, the node creates a forwarding entry for the tree and marks the next-hops attributes as empty. In this case, the node should be one data receiver; and
(4) If reliability is required, either an acknowledgment (ACK) or a negative acknowledgment (NACK) message is sent back, either directly to the initiator or to the parent. In the case of an ACK being sent back to the parent, the parent node should send it to its parent in the tree until such ACK reaches the initiator. The ACK being sent back at the branch point should only be sent back to its parent when all ACKs are received from its children. The NACK from a child other than the first one should be suppressed at the branch point.

A tree descriptor is encoded in in-order or the like; for example, as (a (b (d) (e)) (c (f) (g))) for a complete binary tree with seven nodes. Each node also maintains the node identifier of its parent on a tree in order to send a path-pinning acknowledgement back to the initiator. Each entry in the forwarding table is associated with an aging timer. After the timer expires, the corresponding entry is deleted from the forwarding table. The initiator is then responsible for refreshing the forwarding entry.

Similarly, in the preferred hop-by-hop pinning setup of paths, the initiator encodes the description of each path into a message and sends it to the first node of each path. On receiving such a message, a node performs the following 4 steps:
(1) Extracts the corresponding forwarding entry and installs it in the forwarding table for the corresponding path;
(2) Removes the forwarding entry from the message and sends it to the next node specified by the message;
(3) If the node does not have a next node specified by the message, the node creates a forwarding entry for the flow and marks the next-hops attributes as empty. In this case, the node should be one data receiver; and
(4) If reliability is required, either ACK or NACK is sent back, either directly to the initiator or to the previous node of the path. In the case of an ACK being sent back to the previous node of the path, the previous node should send it to its previous node in the flow until such an acknowledgement reaches the initiator.

A path descriptor is encoded as a list of nodes or the like; for example, as (a, b, d, e, c) for a path traversing five nodes. Each node also maintains the node id of its previous node on the flow in order to send a path-pinning acknowledgement back to the initiator. Each entry in the forwarding table is associated with an aging timer. After the timer expires, the corresponding entry is deleted from the forwarding table. The initiator is then responsible for refreshing the forwarding entry.

In that situation when a new node joins while the previous tree or path is already created, the new node sends a joining message to the initiator and the initiator sets up the trees or path for the node explicitly by installing forwarding tables at the appropriate nodes. Conversely, when a node leaves, the leaving node sends a leaving request to the initiator and the initiator fixes the forwarding table for the trees or paths. In the event of a node failure, the peering nodes of the failed node should notify the initiator to fix the forwarding tables. In this case the localized forwarding table setup is more preferable.

Before transmitting bulk data files, an application will first request a data transfer. Advantageously, at least two types of bandwidth-optimized transfers for applications are provided according to the present invention. Specifically:
(1) The application can request a transfer with bandwidth guarantee specified by some QoS descriptors; and
(2) The application can request a transfer for maximum available bandwidth.

In responding to such a request, the initiator process performs a two-step process to setup the trees or paths. First, the system checks the performance database, either local or centralized, for topology information and uses one or a plurality of optimized algorithms to create bandwidth-optimized trees (other matrices are also possible). Second, the system performs the explicit forwarding table setup, as it was explained before. No assumption is made about the tree or path creation algorithms for the routing protocols.

In the first case, the application request may fail due to the current availability of the network resources. In such an event, the failure notification is sent to the application. The application may further negotiate other QoS requirements, however. Nevertheless, the present invention can reduce such a call-blocking rate, due, in part to, the use of spatial and temporal diversity.

According to the present invention, the data source node is aware of the available data transmission trees and paths created over the overlay network by storing the forwarding table or the like. Before transmitting a block of data, the source node tags the block in its header with an identifier that identifies the tree or path that the block is going to traverse. The forwarding process in each overlay node examines every incoming data block to determine whether it is destined for a local client or further forwarding is required. Such decision is based on the forwarding table or the like, as described before.

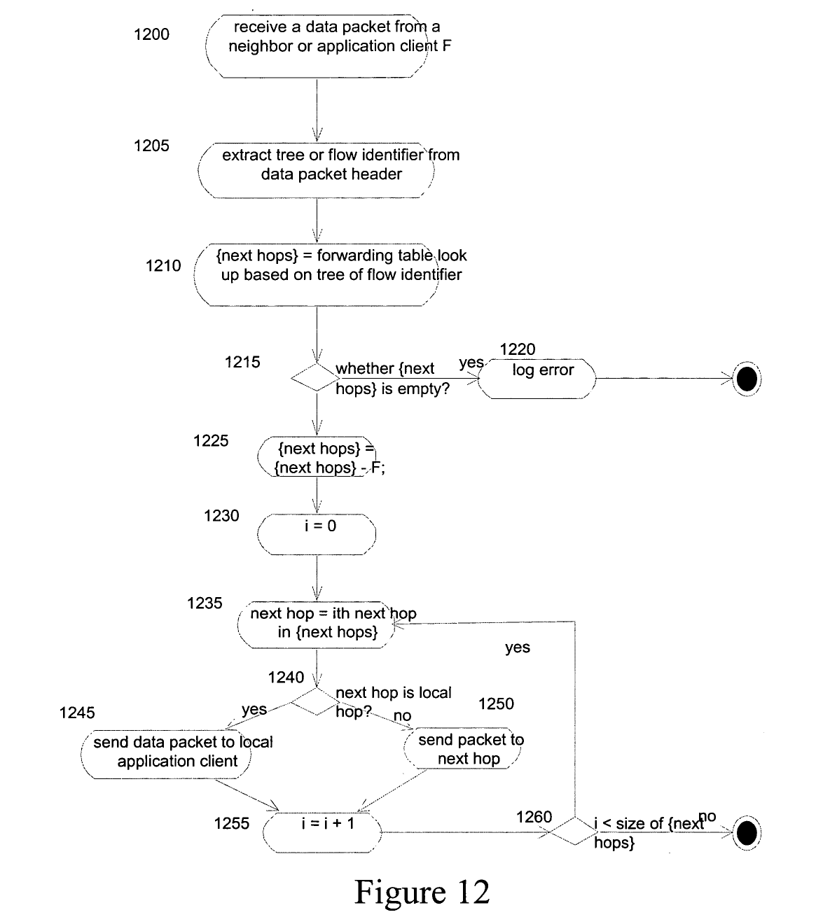

The forwarding process is described as a flow diagram in FIG. 12. Specifically, and with reference now to that FIGURE, upon receiving a data packet from a neighbor or the application clients 1200, the forwarding process first extracts the path or tree identifier from the packet header 1205. The forwarding process performs a forwarding table lookup with the identifier as the key to retrieve the next-hops set 1210. If the next hops set is empty, the forwarding process will drop the packet and log an error 1220. Otherwise, the forwarding process will replicate the data packet for each next-hop in the next-hops set and send the data packet to them 1225-1260. If the data packet is targeting a local application, the data is forwarded to the local application client 1240,1245. As can be readily appreciated, this flow diagram shows only one exemplary method. Of course, numerous modifications can be made without departing from the spirit and the scope of the invention.

In the Internet, where the available bandwidth and other performance metrics may change over time, trees or paths previously created may become sub-optimal while a session of transferring data is still active. According to the present invention, the network performance is constantly monitored, and decisions on whether an old path or tree should be replaced are considered.

If the new paths or trees outperform the old ones by a certain threshold amount, the system sets up a forwarding table of the new paths or trees first, then switches data forwarding to the new trees. In the case of data scheduling being handled by the routing process, such a forwarding table switch is transparent to the user. In the case of data scheduling being handled by the application, the routing process indicates a path or tree switch by calling a callback function to application. In this callback function, the application performs necessary operations to switch to new paths or trees for data forwarding.

According to the present invention, in order to optimize network resource sharing, optimization methods/algorithms discussed previously specify the data transfer rate of each flow. To realize and ensure the rate, the rate scheduling can be performed at source either at the overlay network layer or at the application layer. The advantage of rate scheduling performed at the network is its transparency to application. Unfortunately however, such an approach cannot take advantage of application specific adaptation.

Each tree or path is associated with a data transfer rate. On receiving data from an application client, a scheduling process at the network layer tags each data block with an appropriate tree or path identifier and sends the data block at the rate associated with the tree or path specified by QoS descriptors. As can be readily appreciated, rate scheduling is important at each forwarding process when multiple trees or paths share the same connection (or connections) between two overlay nodes.

Additionally, the forwarding process in each node, other than the data source, also supports QoS scheduling, such as rate scheduling. To perform rate scheduling at each node, data for each tree or path is queued for forwarding. The forwarding process de-queues the data according to the rate specified by each QoS descriptor associated with each tree or path. In the case where the total bandwidth is reduced on a connection due to a temporary congestion, the rate scheduler may schedule the sending rate of each flow in proportion to the rate specified by the paths or trees. In the case where a flow is slowed down due to a congestion on the downstream connection, a backpressure is propagated to the forwarding process of the upstream nodes; the forwarding process will only slow down the sending rate of the corresponding flow.

In one preferred embodiment of the present invention, the routing protocol maintains three different routing metrics in its local database: available bandwidth, delay and loss rate. To monitor the overall network performance, there are two basic strategies: active and passive monitoring. In active monitoring, each overlay node sends probes to the other participating nodes and such probes generally generate excessive network traffic. On the other hand, when there is data transfer in progress between two nodes, passive monitoring can sample such data to create meaningful performance information. The preferred way of network monitoring is to use cooperative active and passive monitoring strategies. Each node uses passive monitoring when there is an active overlay connection to other node, while a node uses active monitoring when such an overlay connection is not present.

In active hop-by-hop available bandwidth monitoring, the preferred embodiment of this invention is to use existing prior art tools such as pathchar (Allen B. Downey, “Using Pathchar to Estimate Internet Link Characteristics”, Proceedings of ACM SIGCOMM 1999”). To map the Internet topology between each end host, the current invention selects traceroute-based technologies such as skitter (http://old.caida.org/Tools/Skitter/) or Rocketfuel (Neil Spring, Ratul Mahajan and David Wetherall, “Measuring ISP Topologies with Rocketfuel”, Proceedings of ACM SIGCOMM 2002).

For small groups, it is possible to create a mesh and have an O(N²) monitoring graph between the overlay network nodes, where N is the number of overlay nodes. For large networks, such a monitoring should be reduced for scalability purposes. The loss of accuracy of such reduction can be mitigated with probe priority and timers.

The routing protocol uses the dissemination of link state and topology information among the overlay nodes, which in turn is used to build the paths, the trees and their forwarding tables. Each node in an overlay network with N nodes, periodically summarizes information changes about its local database and only propagates to its neighbors in the overlay network. The summarized information includes different performance metrics of all O(N²) connections, such as available bandwidth, delay, loss rate etc. Sending link-state advertisement via the overlay network ensures that the routing information is propagated properly in the event of path outages. To stabilize the information propagation, for each metric, the system provides a change threshold that can be set by the applications. Only when the value difference is larger than the is threshold, it should be marked as a change.

In order to make a good routing decision, each overlay node requires a functioning performance database for efficient data logging and summarization. For example, to estimate the routing trip latency, an exponential weighted moving average (EWMA) of round-trip latency of samples can be used. Thus, the database maintains not only the current sampling data but also the previous data. When the data is obsolete, it is removed from the database automatically. The performance database supports queries from both application and routing protocol layers. It also supports data summarization for different data types requests. The performance monitoring agent and client that request performance information should agree on the data type (schema) and procedures.

To bootstrap a participating node into the overlay node of the present invention, the node must know the identity of at least one peer node in the overlay network. For this purpose, the preferred way of the present invention uses a centralized directory service such as DNS, or a distributed directory service such as DHT. In both cases, after successful locating and connecting to its peers in the network, the new node should also register its own identity to the directory. Also, in distributed routing where each node has a database of global overlay topology, the newcomer's information should be propagated to every other node by broadcasting. Such broadcasting should leverage the ability of Link State Advertisement (LSA).

The directory service implemented a soft state identity management, and each node should periodically refresh its own membership in the directory. The period has to be chosen carefully in order to scale. The chosen soft state prevents the node from failing to notify the directory in case of node failure. The peers in the overlay network that connect to the failure nodes, should also notify the network and the directory about such failure. To avoid confusion between a node failure and the path being outrageous, failure notification should only be propagated after a carefully chosen period and such notification should be agreed by the peers and the directory.

To prevent from supplying a newcomer with a stale node identity, the directory gives a list of available nodes in the system. Such redundancy provides robustness. The node list chosen should also consider application-specific optimization strategies, such as geographical proximity and bandwidth availability. For example, in a bandwidth-sensitive application, a node should be chosen such that it still has some residual bandwidth for access. Thus, the directory service should have an application interface for customization.

When running in service mode, the overlay network includes rendezvous nodes. Application nodes connect to one or multiple rendezvous nodes for data transmission. To support multiple sessions over the same overlay network, the present invention provides session management for the applications. In a session, there is a session controller and session members. The preferred way of session management in the present invention is to use a pub-sub framework. In this framework, the session controller publishes its service to the directory and the session members, as subscribers, query the directory for an interested session controller; the subscriber then subscribes to the session controller for its service. An example is bulk data transfer, where the source node publishes the delivery service for certain content in the directory and the edge nodes subscribe to the directory for interest of receiving. Before the source starts transmitting data, it checks the joining receivers and requests the overlay network to setup deliver paths for all receivers.

The preferred way of realizing session management in the present invention is to use centralized session controller. It eases the complexity of management while constituting a single point of failure. To address this issue, a backup controller on the other machine should be able to synchronize with the primary controller and perform fail-over when necessary. The address of the backup node should also be made available to all the subscribers.

The present invention provides a generic infrastructure for high bandwidth content distribution for point-to-point, point-to-multipoint, multipoint-to-point, multipoint-to-multipoint. To distribute bulk data files using an overlay network, the application client connects to the overlay network, encodes the bulk data into strips and schedules data transmission over multiple trees or flows provided by the overlay network. The overlay network helps the application to construct multiple trees for point-to-multipoint, multipoint-to-multipoint transmission, as well as to construct multiple flows for point-to-point and multipoint-to-point distributions.

Applications should agree on the same data-framing format for data delivery. Apart from the sequence number for data delivery, a customized data frame scheme is beneficial for application semantics, simplicity and reliability. For example, an FTP application uses a tuple containing <file name, offset, length> to specify the data frame; a database application uses <objectID>. The transport layer in the present invention should preserve such data naming while forwarding the data.

A preferred way of realizing data transmission between two overlay nodes is to utilize the functionality provided by the underlay communication. Providing reliability for multicast over an unreliable service such as IP or UDP is still a research issue. TCP can provide reliability over a unicast connection. Thus, the preferred way to provide reliable data transmission between a pair of over nodes is to leverage robust and congestion friendly TCP that can help prevent data loss.

Due to the heterogeneity of the network however, transmission of data from a fast link to a slow link may become problematic. In the present invention, a preferred way is to create trees such that each tree link transmits data at the same rate. In response to a temporary congestion, a finite buffer is used to ease the bandwidth fluctuation. For a long-time congestion, backpressure is used to slow down sending rate up to the source.

There is still a possibility of loss of data however, mainly due to the network transition, tree transitions, link failures and node failures. To achieve total reliability, applications should provide their reliability semantics and recovery mechanics. An example would be applications requesting retransmission, content reconciliation between peers and erasure coding.

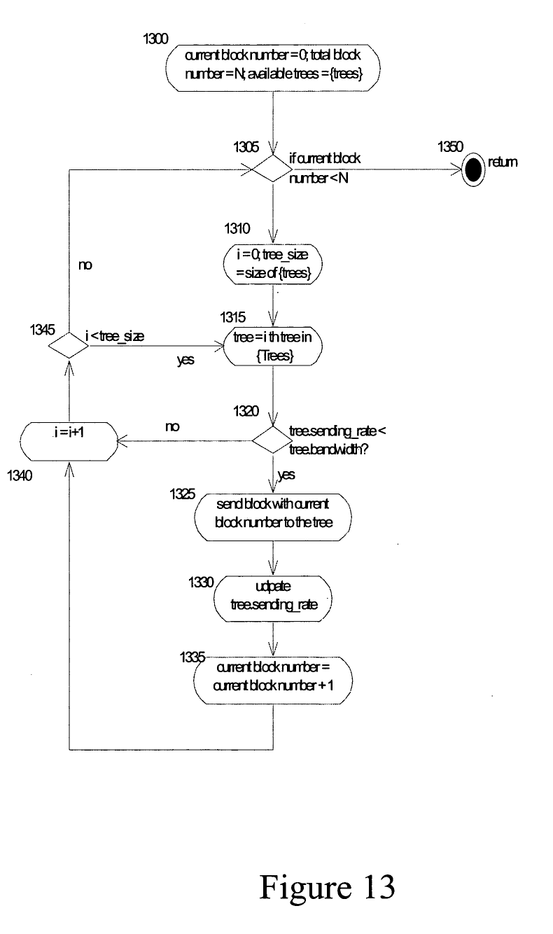

To schedule data transmission, an application must encode the data such that each strip requires bandwidth according to the resources provided by each path or tree. Also the bandwidth may vary in response to network congestions. In a stable network and static traffic scenario, the application can choose a static partition in advance. But in a dynamic network, the portioning of strips should be dynamic. In static partitioning of a file composed of N blocks {0,1, . . . N} for two paths or trees with respective available bandwidth BW1 and BW2, for example, the present invention partitions the file into two strips wherein the first strip consists of block {0, 1, . . . , └BW1/(BW1+BW2)*N┘} while the second consists of block {└BW1/(BW1+BW2)*N┘+1, . . . N−1, N}. In dynamic partitioning, data blocks of a file are sent sequentially to paths or trees as illustrated by, for example, the diagram of FIG. 13.

Turning our attention now to that FIG. 13, before the data source sends a data block to a tree, it first checks whether such a transfer violates the allowed bandwidth on the tree 1320. If it is not violated, the data block is sent out through the tree and the related data such as the data sending rate is updated 1325,1330; otherwise the scheduling process skips the current tree and checks for the next tree 1340. If sending one data block is successful, the block pointer is incremented by one 1335. If the block pointer is larger than the total block size, the file transfer finishes 1350. In dynamic partitioning, even though the bandwidth changes, the algorithm should still be able to perform load balancing among all the trees.

Of course, the method depicted in FIG. 13 demonstrates just one embodiment of the procedure. It will be apparent to ones skilled in art that numerous implementations are possible depending on the programming model, for example multithread.

At the receiver, the reassembly process is responsible for putting out of order data blocks into their original order. The routing process with the help of buffering can perform such a reordering process. However, due to semantics of many applications, such as large data dissemination, maintaining a complete ordering at a participating overlay node by using buffering becomes problematic. Thus, in the present invention, the application itself defines its frame format and encodes data into an application-defined frame for subsequent transferring; at the receiver side, the application uses this encoded frame to reconstitute the data.

In order to tolerate the loss of a subset of strips, some applications may provide a mechanism to fetch content from other peers in the system, or may choose to encode the content in a redundant manner. For example, a media stream could be encoded using Multiple Description Coding (MDC) so that the video can be reconstituted from any subset of k strips with video quality proportional to the number of strips received. Such an encoding also allows low-bandwidth clients to receive the video at lower quality by explicitly requesting fewer strips. Another example is the dissemination of data, where each data block can be encoded using erasure codes to generate k blocks, such that only a subset of the k blocks are required to reconstitute the original block. Each strip is then used in the different multicast trees for transmitting data blocks.

In summary, we have developed a novel method and apparatus for optimized data transmission utilizing the unused network resources. When practiced, the invention advantageously provides practical, efficient, and an economical mechanism for improving data distribution. Of further advantage, the mechanism is highly transparent, as well, and does not necessitate changes in underlying network protocols, such as IP.

In describing our invention, detailed descriptions of the methods and algorithms employed were provided. Examples and analysis show that significant performance improvements can be achieved through the use of our invention. And while the above description includes many specifics and examples, these should not be construed as limitations on the scope of the invention, but rather as exemplification of a preferred embodiment thereof.

As can be readily appreciated by those skilled in the art, many other variations are possible. For example, while the previous examples were presented in terms of an IP network like the Internet, the present invention is applicable to networking protocols other than IP, and to other network layers and communication protocols including but by no means limited to http, ftp, TCP, and SSL. The invention is applicable as well to packet-switched networks other than the Internet, and to other static-topology networks (whether packet switched or connection-oriented). Finally, the same mechanisms can be used where other network properties are optimized (e.g., security), and can be realized with software-only implementations, such as by using active networks infrastructure, or other available computational resources).

Of course, it will be understood by those skilled in the art that the foregoing is merely illustrative of the principles of this invention, and that various modifications can be made by those skilled in the art without departing from the scope and spirit of the invention, which shall be limited by the scope of the claims appended hereto.

1. A method for distributing data between a source and destination in a network, the method comprising the steps of:
defining, n number of paths between the source and the destination;
splitting the data into n number of blocks independently transmitting the n blocks from the source to the destination; and
reassembling, at the destination, the n blocks into the data.

2. The method according to claim 1 wherein the independent transmission of the n blocks is not started simultaneously.

3. The method according to claim 1 wherein the size of the n blocks remains constant for the duration of the transmission.

4. The method according to claim 1 wherein the size of the n blocks varies during the duration of the transmission.

5. The method according to claim 1 wherein the n number of paths is determined using multicast, depth-first-search technique.

6. The method according to claim 1 wherein the n number of paths is determined using multicast spanning tree technique.

7. The method according to claim 1 wherein the n number of paths is determined using multicast arborescence technique.

8. The method according to claim 1 further comprising the step of:
receiving, at the source, a request for a data transfer to the destination.

9. A method of file transfer in a computer-based communication network by utilizing an overlay network composed of cooperating servers on computer hosts, said computer hosts connected to said communication network, wherein each said server contains instructions which, when executed by said server, cause said server to process and forward data via the transport layer to other servers on said overlay network without modifying the native data transport protocol at transport or lower layers, said method comprising the steps of:
defining a first data forwarding path between two servers, said path comprising of concatenation of overlay links, each of said links established via transport layer between two said servers in said overlay network;
defining a second data forwarding path between two servers, said path different from the first data forwarding path;
dividing the data file in at least two sub-files, first sub-file and second sub-file; and
sending first and second sub-files over the first and second data forwarding paths, respectively.

10. The method according to claim 9 further comprising the steps of:
replicating each sub-file in one or more intermediate servers on said data forwarding paths and forwarding the sub-file to the next server in the path; and
assembling the first and the second sub-files at the second server.

11. The method of claim 9, wherein said sending first and second sub-files over the first and second data forwarding paths are not started simultaneously.

12. The method of claim 10, wherein said sub-files are transmitted from a single source node to a plurality of destination nodes, and said paths form a data forwarding tree, wherein the intermediate nodes of the tree copy the sub-files reaching them from the incoming overlay link to the plurality of outgoing overlay links.

13. The method of claim 9, wherein said sub-files are transmitted from a plurality of source nodes to a plurality of destination nodes, and said forwarding paths form data forwarding trees, wherein the intermediate nodes of the tree copy the data reaching them from the incoming link to the plurality of outgoing links.

14. The method of claim 9, wherein the data forwarding and processing resources are reserved, said resources including one or more metrics from the following group: bandwidth of overlay link, processing load of the server.

15. The method of claim 9, wherein the data forwarding and processing resources are determined from network monitoring, said resources including one or more metrics from the following group: bandwidth of overlay link, processing load of the server.

16. The method of claim 9, wherein the said overlay network has static topology and resources, said resources including one or more metrics from the following group: bandwidth, processing load.

17. The method of claim 9, wherein the said overlay network has dynamic topology and resources, said resources including one or more metrics from the following group: bandwidth, processing load.

18. The method of claim 9, wherein the data forwarding paths are computed in a single server.

19. The method of claim 9, wherein the data forwarding paths are computed in several servers, with subsequent coordination of computed results.

20. The method of claim 9, wherein the divisions of the data file into sub-files remain constant for the duration of the file transfer.

21. The method of claim 9, wherein the divisions of the data file into sub-files change during the file transfer.

22. The method of claim 11, wherein the data forwarding tree is constructed using multicast depth-first-search method.

23. The method of claim 11, wherein the data forwarding tree is constructed using multicast spanning tree method.

24. The method of claim 11, wherein the data forwarding tree is constructed using multicast arborescence method.

25. The method of claim 9, wherein the established communications protocols include one or more protocols selected from the following group: Internet Protocol, http, ftp SSL, TCP reliable UDP using erasure coding.

26. The method of assembly of claim 12, wherein the assembly is done at overlay network layer, said method comprising the steps of:
encoding a monotonically increased sequence number in each packet header at data source.
queuing data packet in a sink buffer in destination for each data transport session.
scanning a sink buffer and selecting a data packet that matches the current receiving sequence number maintained at the destination.
clocking out available data packets in the sink buffer selected by step c);
increasing the receiving sequence number at the destination.
delivering the available data packet to the application client; and
repeating the method for all sink buffers.

27. The method of assembly of claim 12, wherein the assembly is done at the overlay application layer by the application, said method comprising the steps of:
encoding an application-specific data object identifier into a data frame;
extracting the application-specific data object identifier at the destination; and
reassembling the application data object according to the data object identifier.

28. The method of data transfer of claim 9, said method comprising the steps of:
using an explicit or implicit method to setup the forwarding table in each overlay node;
forwarding the data by looking up the forwarding table installed by step a) at each node;
scheduling data transport at the data source and at each intermediate node for each path or tree according to their QoS specifications; and
slowing down a particular data flow on a path or tree by using backpressure.

29. The method of claim 9, wherein the transport of data partitions to a plurality of destination nodes is a combined coordination of transport initiated by the sender (push) and transport initiated by the receivers (pull).

30. An overlay network apparatus for determining optimized paths and trees for transmitting data from a source to destinations within a computer-based communications network, the communications network being characterized by one or more established communications protocols, the apparatus comprising:
a set of one or more intermediate nodes, the intermediate nodes being operable to transmit and receive data in conformance with the established communications protocols;
path and trees discovery means, responsive to a request for transmitting data from the sources to the destinations, operable to discover network resources on virtual links between the sources and the destinations passing through one or more of the intermediate nodes, the paths being derived by means of one or more existing routing mechanisms of the communications network, wherein the intermediate nodes define a virtual topology on top of the computer-based communications network;
data processing means for data partitioning, storage and replication at the nodes; and
forwarding means for forwarding the data from the sources to the destinations by way of paths and trees, without requiring a modification of the established communications protocols.
